(19) United States
(12) Patent Application Publication
(10) Pub. No.: US 2012/0104744 A1
(43) Pub. Date: May 3, 2012

(54) HOSE CONNECTORS WITH SLEEVES AND THEIR SELECTED INCLUSION IN A UNIVERSAL KIT FOR FORMING A VARIETY OF HOSE SYSTEMS

(76) Inventor: Jon A. Petty, Bicknell, UT (US)

(21) Appl. No.: 12/916,576

(22) Filed: Oct. 31, 2010

(51) Int. Cl. F16L 21/00

(52) U.S. Cl. 285/31

(57) ABSTRACT

A universal kit of selected connector fittings for connecting hose ends together, forming a web of hoses of a vehicle vacuum or pressure system, where the fittings are maintained in a container and include, as a primary connector, a CNC Rotator assembly, that has a metal like rotator sleeve that receives a nylon collar press fitted therein that includes a locking arrangement formed therein, alongside a molded helix thread, which locking arrangement is to pass and lock to a ridge of a snap-barb fitting, and a circular plate of a twist-barb fitting is fitted to turn in the molded helix thread to releasably lock in the rotator sleeve when twisted, and the snap-barb and twist-barb fittings include hose barbs to connect hose ends thereto, and the kit further includes items such as quick coupling tees, elbows, coupling unions and shrink sleeves for forming a web of vacuum or pressure hoses for a vehicle.

### BACKGROUND OF THE INVENTION

1. Field of the Invention

This invention relates to tube and hose quick-connect fittings that are selected for inclusion in a universal kit of connector components for assembly of a vacuum or pressure hose web for a vehicle.

2. Prior Art

When one looks under the hood of a vehicle, one sees what seems to be an intricate highway of electrical wiring and hoses connecting different points of the engine to electronic, plastic and metal components. The web of vacuum and pressure hoses, lines, and tubing is an integral part of each engine and is unique from one vehicle to another. The invention employs a universal kit concept where by a selection of key connector components for inclusion into a single universal kit provide a variety of hose and tube web configurations that can be formed utilizing selected components as are found in the kit to quickly connect hoses or tubes together forming a pressure or vacuum system web for practically any vehicle. From the single universal kit a person can create a hose or tube web to fit their specific need.

A kit has been created for the invention in a universal system that is designed to accommodate a multitude of vehicle types, requiring an accommodation to different hose sizes and custom applications. Formerly, fittings and connectors have been sold individually or, where the components have been packed together, such package is for fitting to an individual vehicle. Seeing a need, the invention recognizes the market value in providing a universal kit where a purchaser can be assured that they will have sufficient and appropriate connectors and fittings for the formation of a web of vacuum or pressure tubes or hoses for their particular vehicle.

The vehicle vacuum system that is one of the systems the invention is appropriate for forming a tube or hose matrix for, provides a lower atmospheric pressure and basically transforms an automobile engine into a huge pump that sucks air, mixes it with fuel, and expels it along with combustion gases. Consequently, even light damage to one of those vacuum conduits can cause performance problems, from a rough idle to a non-starting engine. In addition to vacuum connections, turbo systems and emission controls use pressure conduits to help control proper engine operation. Thus, modern engines count on air-tight and leak proof hose connections for proper functioning and performance.

Previously for a repair of such existing vacuum/system, pressure hose connectors as have been used have had limitations. Currently, such pneumatic connections are made with a hose barb-type retainer fitting to connect the hose to a vacuum or pressure device. As, in such arrangement, the hose is exposed to heat, the tubing becomes hard and brittle, making separation of the hose from the barb unlikely. In fact, in many cases, the hose must be cut off, or the barb itself breaks off, of the component during separation. It is also time consuming when a component (like a carburetor or Throttle Body Injection unit) with vacuum or pressure connections, must be removed from the vehicle or serviced because each hose, line, or tubing connection often has to be separated to make such repair.

Another common problem is that a hose is often damaged when removed from a barb, from another hose fitting, or from a vacuum/pressure component, requiring replacement of the entire hose. Even when a non-barbed hose fitting is used, often it is connected such that it becomes very difficult to disconnect.

These and other problems are met and overcome by a utilization of the components of the universal kit of the invention, as set out and described below, that provides for linking tube or hose sections together so as to provide a more reliable web of tubes or hoses, and allows for conveniently connecting and disconnecting the hoses or tubes into a web to fit efficiently within an available space.

### SUMMARY OF THE INVENTION

It is a principal object of the invention to provide a selection of coupling components assembled as a universal kit that a person selects coupling connectors from as components for joining tubes or hoses into a web of tubes or hoses, forming of a vacuum or pressure system for most vehicles.

Another object of the invention is to provide a universal kit containing coupling connectors as are components of a two part system of permanent snap-lock assembly and releasable quick coupling connectors for joining tubes or hoses together to form a web of hoses of a vacuum system or the like, with the coupling connectors selected to provide for turning joints that can be easily and conveniently separated.

Another object of the invention is to provide a universal kit of core modular coupling components for selection of only the fittings or components as are required for forming a particular vacuum or pressure tube or hose web for any one of a multitude of vehicles.

Another object or the invention is to provide quick coupling fittings that each consist of at least one male snap-barb fitting coupling into a sleeve with locking collar insert and one female twist-barb fitting, where the fittings quickly and surely fit and couple together within the sleeve locking collar at ends that are dimensionally constant, and include uncoupled ends that each include a hose barb end section that is dimensionally variable to allow a particular diameter of hose end to be press fitted over the barb, preventing removal of the hose without an application of significant force.

Another object of the invention is to provide, as a component of the system, a metal or metallic sleeve that can be of a length to cover standard CNC snap-barb and twist barb fittings, or can be of an increased length to cover all the hose barb end sections of which fittings, and the metal sleeve includes a nylon collar press fit into the sleeve that has internal radial one-way flexing fingers in one end to couple to the snap-barb coupling end, and has helical threads formed in the other nylon collar end to receive a coupling disk of the twist-barb fitting turned to lock the female fitting therein to complete the sleeve assembly.

Still another object on the invention is to provide, as the female fitting, a twist barb fitting that has one disk end having a thread formed around its outer surface end designed to quickly and surely mate, by turning one half to three quarter turn, in the sleeve nylon collar helical threads, and provides a hose barb coupling end having constant geometry that is to receive the male snap-barb fitting, that also has constant geometry, to provide an open passage through the end to end coupled fittings, and the female twist-barb and snap-barb fittings hose coupling ends have variable geometry to accommodate hose ends with different internal diameters, providing for coupling to ends of a variety of hoses of different internal diameters.

Still another object of the invention to provide, as the male portion of a two part coupling, a metal or metallic sleeve that is press fitted over a nylon collar that includes internal one-way flexing fingers that will permanently engage and lock to a ridge formed around the snap-barb member end for coupling into the female member, the male and female members providing a passage therethrough, with the rotator sleeve and snap-barb member providing the male component that receives the female component, with the coupled male and female members forming a CNC Rotator assembly, that is the primary quick coupling of the universal kit of the invention.

Still another object of the invention is to provide a shrink sleeve or tube for sliding over the coupled connectors that, when heated, as with hot air, will shrink to closely fit around the coupled connectors and hoses ends, sealing over the junctions of the connectors and hose ends, preventing leakage in a vacuum system, provides evidence of tampering if the sleeve is disturbed and providing a decorative appearance to the finished web.

Still another object of the invention is to provide, a kit that, in addition to the metal rotators, male snap-barb inserts and female twist barb fittings, contains specialty fittings that serve to enhance the utility of the invention for quickly forming tube and hose webs for reconstruction of vacuum and pressure hose system in most appropriate vehicles, and which additional components include, but are not limited to quick couple tees, ninety degree elbows, unions, adaptors, formed from plastic and rubber, and the like, as are needed to reconstruct vacuum and pressure tube and hose webs for most appropriate vehicles.

The universal kit of the invention is an assemblage of quick couplers and related components that provide a capability to a person to quickly and easily form a vacuum or pressure hose web for a wide range of vehicle specific applications to include, difference hose layouts for different internal diameter hoses from a selection of components, from the single kit. The kit may be any contained in an appropriate container but it is preferred that the container be compartmented, with each compartment to accommodate a same or like components. In practice, a rectangular container having a center dividing wall separating upper and lower sections, that each have rectangularly compartments on opposite sides of the center dividing wall, and hinged lids for selectively covering the top and bottom sections of the container, has been used as the container of the invention. Which container provides access to a top or bottom half by opening the one lid with the other lid held closed.

The selection of the couplings and accessories maintained in the container applies a modular product architecture approach, making possible the arrangement of the universal kit of the invention, providing core modular components that a person selects from, as are needed, for forming a specific vacuum or pressure web of hoses for a particular vehicle. Of course, more connectors and accessories are provided than are needed for any one particular application, with the left over components being surplus. So arranged, a universal kit is provided, that greatly reduces retail stocking requirements to meet essentially any pressure or vacuum hose web need and avoids a wrong selection by a person looking to repair a particular system. Further, the separate metal, preferably formed from aluminum, rotator sleeve, and its nylon collar, along with the nylon snap-barb insert, when fitted together, forms the male member of the primary connector that receives a removable female twist-barb fitting, that is preferably formed from nylon plastic, for assembling the CNC Rotator assembly. Nylon is the preferred material for forming components of the kit, though, it should be understood, other inexpensive plastic material or materials could be so used, with essentially a universal metal sleeve with collar insert for forming the assembly provides a less expensive connector, by half, over conventional pre-connected male and female members of conventional quick coupling devices that, further unlike the invention, do not rotate as does the sleeve of the invention that freely rotates around the snap-barb and twist-barb coupled ends. Also, as the CNC Rotator assembly of the invention snap-barb and twist barb fittings can each have different hose barb coupling ends, this allows for a formation of a web of hoses or tubes having different inside diameters by only a selection of a snap-barb and twist barb fitting that have an appropriate hose barb coupling end for the particular hose or tube, and coupling these fitting through one metal rotator sleeve and nylon collar In practice, the universal kit needs only one size of metal rotator sleeve and nylon collar to accommodate all the snap-barb and twist bar fittings, with the snap-barb and twist-barb fittings having variable geometry hose barb ends to connect to hose ends of varying diameters, greatly simplifying the selection of components for inclusion into the kit of the invention. Accordingly, in addition to the lesser cost of manufacture of the connector components of the kit of the invention, a single kit for use for most vehicles provides a space and cost savings to the retailer who stocks only the universal kit of the invention to fill most customer needs, and simplifies shopping for appropriate fitting for construction of a hose web for a particular vehicle by a user, providing a major improvement over a single application kit or a purchase of the separate connectors and hoses.

Unique to the invention, the CNC Rotator assembly provides a two-part component that combines a metal rotator sleeve, preferably an anodized aluminum sleeve, that is pressed over a nylon collar that is molded with an internal locking collar that has internal one-way flexible fingers that will permanently engage a ridge in the snap-barb fitting passed into the open center of the locking collar when the rotator sleeve and fitting are pressed together, forming the male member. Which nylon collar also has molded helix threads that the twist-barb female fitting, disk end is turned into, maintaining the male and female members together in sealing engagement. This combination of a metal rotator sleeve and nylon internal locking collar with the installed male and female fittings, that are also preferably nylon, provides an inexpensive CNC Rotator assembly that is unique to the invention. The CNC Rotator assembly rotator rotate independently, preventing hose twisting during assembly or disassembly. Each rotator sleeve of the kit has the same internal mating dimension allowing them to be used with any of the nylon snap-barb and twist-barb fittings that have various size hose bar ends, providing for a use with any appropriate inside diameter of hose, minimizing the number of components as are needed for the universal kit. Further, for providing added utility, the metal rotator sleeve can be formed in different lengths to provide, as required or desired for appearance, a longer sleeve, for covering the snap-barb and twist barb fittings, and to compensate for the small diameter of the nylon collars that may be difficult to grip. Further, a larger outside diameter of rotator sleeve of the invention maybe employed, also for improving the appearance of the connection.

For the invention, where the mating dimensions of the rotator sleeves, nylon collars, and snap-barb and twist-barb fittings have the same connection geometry, with the diameter of the respective hose barb ends of which snap-barb and twist-barb fittings have variable geometry to accommodate hoses having a variety of inside diameters.

The invention, in addition to the above set out primary CNC Rotator assembly sleeves, nylon collars and fittings, includes quick coupling tees and angle fittings, and in-line couplings, unions and adaptors that will accommodate the architecture of most vehicles as the kit can be use with for forming hose webs for the vehicle. Additionally, the kit includes shrink sleeves or tubes that are for sliding over a hose end to cover a coupling point or a bend in a hose. Heat is then applied to which sleeve or tube, shrinking it into sealing arrangement over the connector and hose ends. Providing a close fit over the joint, maintaining a vacuum seal at the joint, and will maintain the bend as was formed in the hose.

Various other purposes and advantages of the invention will become clear from its description in the specification that follows. Therefore, to the accomplishment of the objectives described above, this invention includes the features hereinafter fully described in the detailed description of the preferred embodiment, and are particularly pointed out in the claims. However, it should be understood such description discloses only some of the various ways in which the invention may be practiced.

### BRIEF DESCRIPTION OF THE DRAWINGS

The invention may take physical form in certain parts and arrangement of parts, and the preferred embodiments of which will be described in detail in the specification and illustrated in the accompanying drawings which form a part hereof

FIG. 1 shows an example of a matrix of connected hoses of a vacuum system formed utilizing selected quick coupling rotator sleeves, permanent snap-barb and releasable twist-barb fittings forming CNC Rotator assemblies with shrink sleeves or tubes as are found in a universal kit of the invention;

FIG. 2 shows an example of a rectangular container for maintaining the universal kit of connectors and has dividing walls that are accessed by opening either a top or bottom lid;

FIG. 3A shows a side elevation perspective view of a rotator sleeve with a nylon collar that incorporates one-way flexible fingers and shows a snap-barb fitting aligned for installation therein;

FIG. 3B shows an end perspective view of the rotator of FIG. 3A with a coupling end of the snap-barb fitting positioned into the nylon collar;

FIG. 3C shows the snap-barb fitting of FIGS. 3A and 3C installed in the rotator sleeve;

FIG. 3D shows a modular tee fitting having a coupling end for installation into the nylon collar of the rotator sleeve, passing through the collar flexing fingers or turned in helix threads of which nylon collar;

FIG. 4 shows a side elevation perspective view of a female twist-barb fitting that is for coupling into the rotator sleeve that contains the snap-barb fitting of FIGS. 3A through 3C;

FIG. 5A shows the female twist-bath fitting of FIG. 4 aligned for fitting over the male portion of the snap-barb fitting of FIG. 3C that has been fitted into the rotator sleeve;

FIG. 5B shows the assembled rotator sleeve and snap-barb fitting of FIG. 3c with the female twist-barb fitting of FIG. 4 installed therein, and includes ends of hoses, shown in broken lines, fitted onto hose barb ends of the female twist-barb and snap-barb fittings;

FIG. 5C shows a CNC Rotator assembly with a second rotator sleeve positioned alongside, over the twist-barb fitting;

FIG. 5D shows a sectional view of the CNC Rotator assembly and the second rotator sleeve of FIG. 5C showing that the second rotator sleeve does not include the nylon collar, with the second sleeve shown installed onto the twist-barb fitting ring portion, alongside the CNC Rotator assembly end covering all but the nose end of the fitting hose barb end;

FIG. 5E shows a side elevation sectional view taken along the line 5E-5E of FIG. 5B;

FIG. 6A and 6B show end perspective views of a second longer rotator sleeve taken from opposite ends thereof, respectively, showing a nylon collar has been in-set into longer rotator sleeve to accommodate a twist-barb fitting turned therein;

FIG. 6C shows a side elevation view of the CNC Rotator assembly that includes the sleeve of FIGS. 6A and 6B;

FIG. 6D a side elevation sectional view of the CNC Rotator assembly as a fully assembled coupling taken along the line 6D-6D of FIG. 6C;

FIG. 7A shows a side elevation view of the hose barb end of the female twist-barb fitting aligned for insertion into a straight rubber sleeve connector of the kit;

FIG. 7B shows the female twist-barb fitting hose barb end installed in the straight rubber sleeve connector of the kit;

FIG. 7C shows the twist-barb fitting and rubber sleeve connector of FIG. 7B with the twist-barb fitting disk plate turned into helical threads of the rotator sleeve nylon collar of a CNC Rotator assembly,

FIG. 7D is a view like that of FIG. 7C only showing a connector elbow as having replaced the straight rubber sleeve connector;

FIG. 8A shows a hose lock that includes a rotator sleeve aligned to receive a plastic fitting press fit therethrough whose other end has a hose barb that is fitted through an insert that a locking collar is passed over and extends into the rotator sleeve;

FIG. 8B shows the components of FIG. 8A fitted together, and shows a hose end cap to be fitted thereto;

FIG. 8C shows the assembled components and hose of FIGS. 8A and 8B and cap;

FIG. 8D shows an enlarged view of the assembly of FIG. 8C, with the cap turned over the twist-barb fitting disk plate

FIG. 8E shows a side elevation sectional view taken along the line 8E-8E of FIG. 8D.

FIG. 9A show a side elevation view of a hose that has been bent and has had a heat shrink sleeve or tube fitted thereover; and

FIG. 9B shows the bent hose of FIG. 9A with the heat shrink sleeve or tube as having been heated and has shrunk to fit snugly to the hose at the bent.

### DETAILED DESCRIPTION

The invention is described in the following description with that reference the figures, in which like numbers represent the same or similar elements. The described features, structures, or characteristics of the invention may be combined in any suitable manner in one or more embodiments. In the following description, numerous specific details are recited to provide a thorough understanding of the invention One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The invention is in a single universal kit 11 containing an assemblage of connector fittings and components selected to provide to user with a capability to connect hoses into a web for upgrading standard and conventional hose vacuum and turbo hose systems, for accommodating hundreds of vehicle types to include different size of hoses and custom applications. The creation of a single universal kit of connectors for the multitude of different vehicle configurations greatly simplifies a retail store stocking requirements and provides an assurance to a purchaser that they have made the correct purchase to meet their vehicle requirements. The invention solves the problem of producing a universal kit by a selection of core modular components that allow the user to assemble only the fittings as are required for their unique application. In practice, the modular product architecture of the components makes the kit assembly possible.

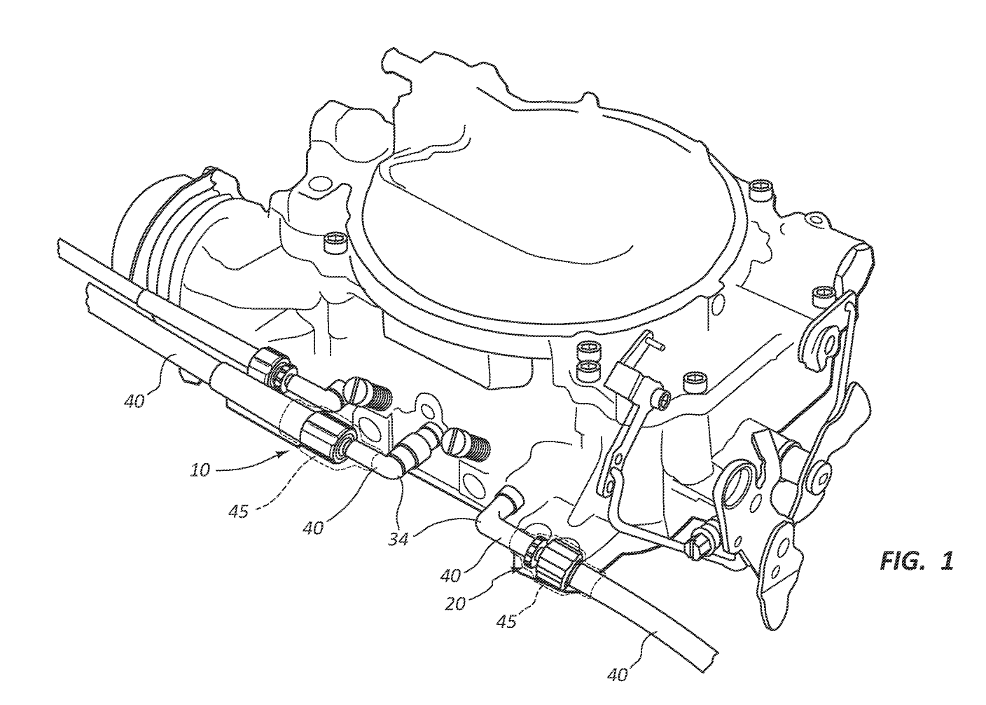

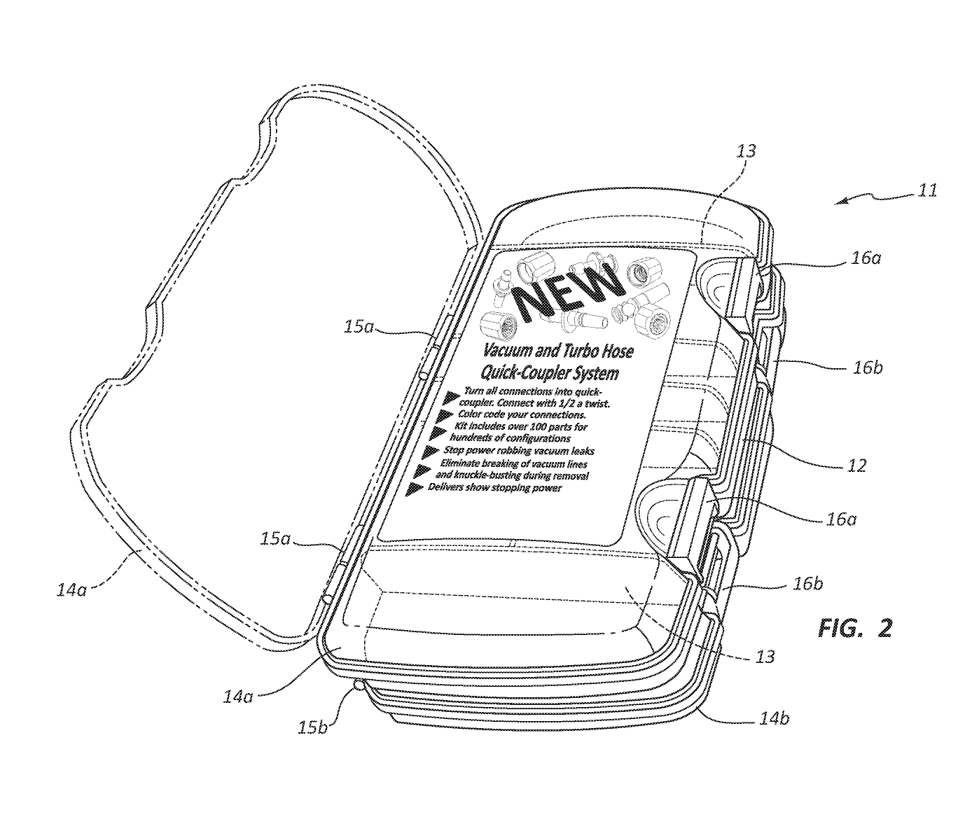

FIG. 1 shows an internal combustion engine carburetor having a web of hoses 10 that include CNC Rotator assemblies and twist-barb fittings that connect to rubber connectors 34 that are fitted onto barb fittings of the carburetor manifold, with snap-barb fittings of CNC Rotator assemblies connected to hose 40 ends, with one of the CNC rotator assemblies shown as having had a heat shrunk sleeve 45 installed thereover. FIG. 1 shows an example of a use of the universal kit of the invention for providing hose couplings for assembly with hoses, forming a hose web. Which universal kit is illustrated in FIG. 2 as a rectangular box 11 having a body 12 with a center divider plate that divides the body into identical upper and lower sections that each have interior walls 13 that cross to form individual compartments. The body 12 upper and lower sections each has a lid 14a or 14b, respectively, that is connected to a body edge by hinges 15a and 15b, respectively, and which lids can be locked in covering attitude by latches 16a and 16b, respectively. The lids 14a and 14b are preferably concave over their outer surfaces and the height of the interior walls 13 are selected such that the top of each wall engages the lid 14a or 14b inner surface forming separate compartments to accommodate selected connectors and components. It should, however, be understood that another container for maintaining the selected connectors that make up the universal kit of the invention could be used, within the scope of this disclosure.

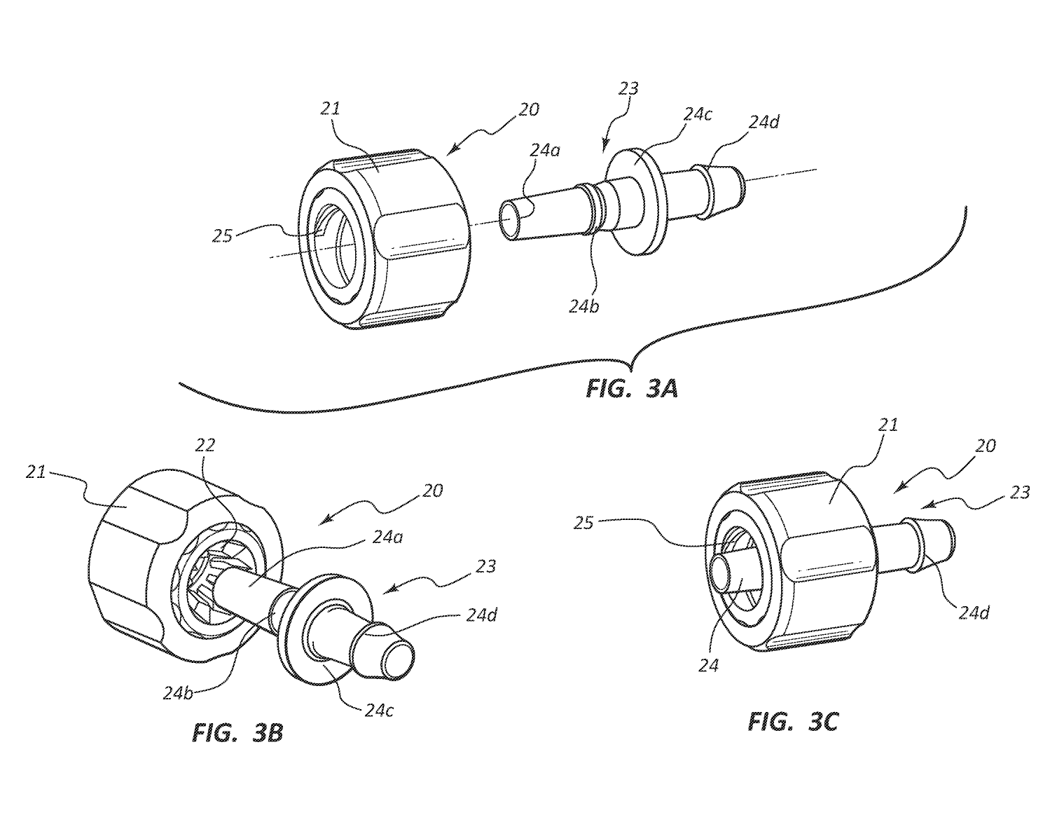

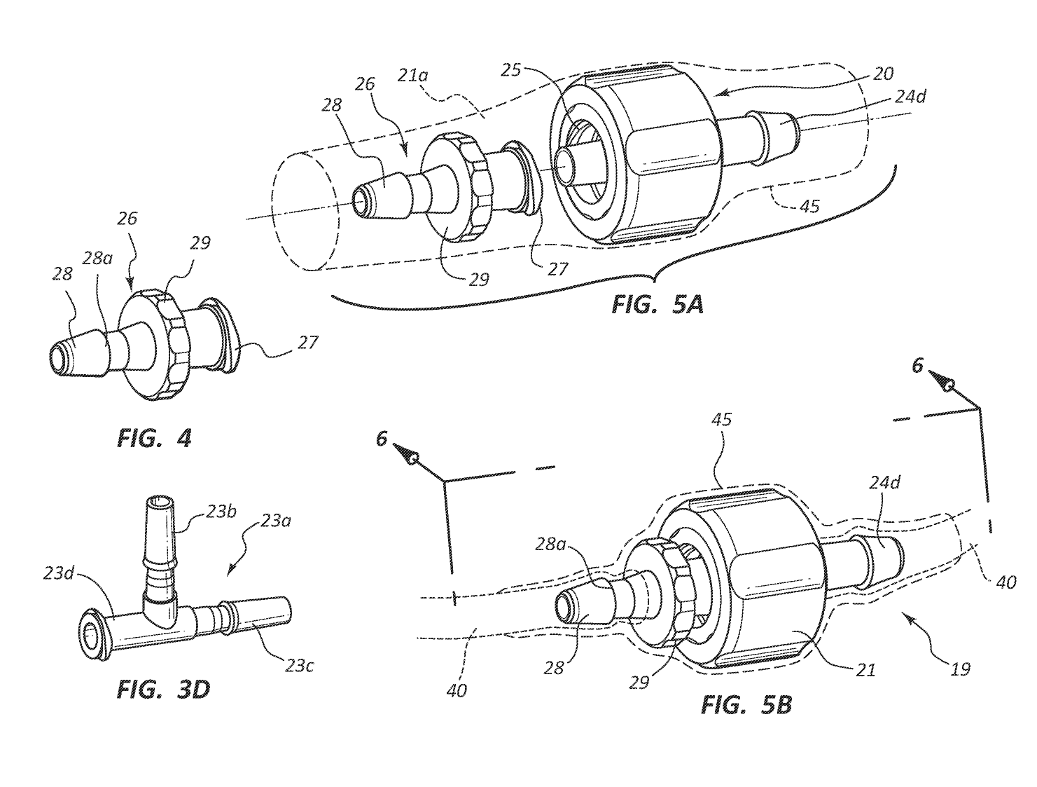

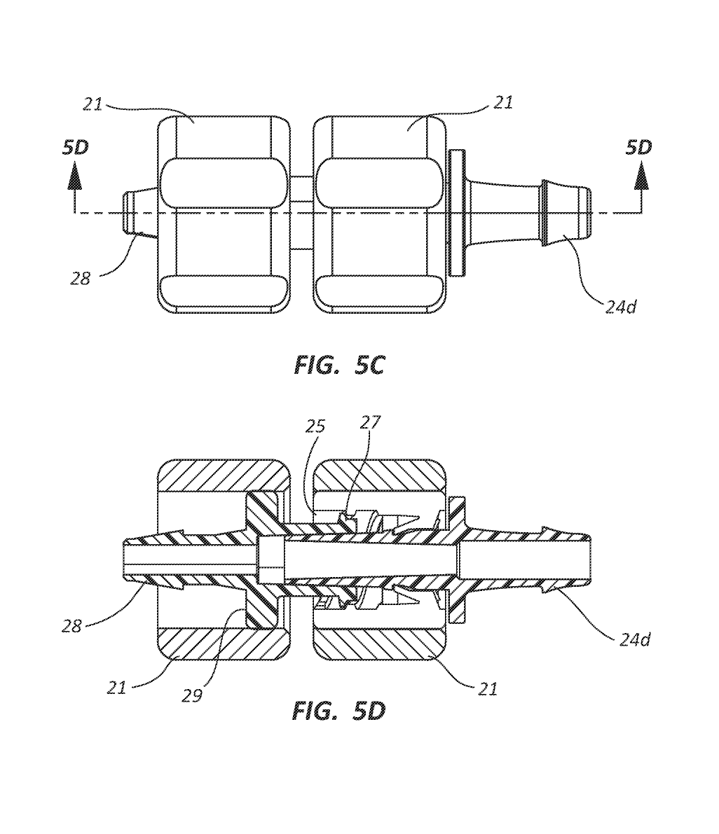

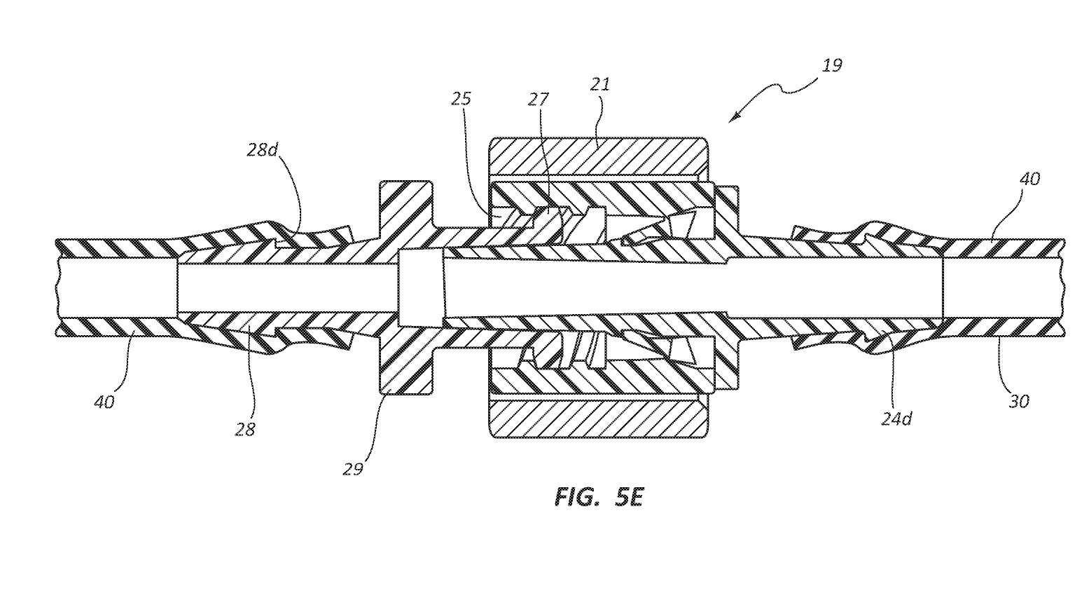

Modular product architecture must be taken into account to provide for connecting hoses that may have different internal diameters along with the engine or carburetor connection configurations that hose ends need to couple to. To minimize the number of connectors as are required in a kit, the invention includes, as the primary coupling, CNC rotator assembly 19, as shown in FIG. 5B, that is a combination of a rotator assembly 20, shown in FIGS. 3A through 3C, that is formed from metal, preferably aluminum, consisting of rotator sleeve 21 that is press fit over a nylon collar 22 that has internal one-way flexible fingers extending from an open center to the collar inner surface, as shown in FIG. 3B, that receives a coupling end 24a of a snap-barb fitting 23 that has a ridge 24b to fit through the nylon collar 22 open center and lock against the flexible fingers ends. Ridge 24b is formed around the snap-barb fitting center, and the opposite snap-barb fitting end is formed into a hose barb 24d end. Installation of the snap-barb fitting 23 into the rotator sleeve 21 nylon collar 22, completes the assembly of the rotator assembly 20, as shown in FIG. 3C. To form the rotator assembly 20, nylon collar 22 is press fit into the rotator sleeve 21, that also includes interior molded helix thread 25, shown in FIGS. 3A, 3C and 5A. Additionally, FIG. 3D shows a tee fitting 23a that is a replacement for a snap-barb or twist-barb fitting and is also preferably formed from nylon and is arranged for coupling either two male legs 23b and 23c thereof that include ridges, like the ridge 24b of the snap-barb fitting 23, into the rotator sleeve 21 nylon insert 22, with a third female leg 23d as a replacement for a twist-barb fitting that includes a disk plate having a screw thread as its outer surface for turning into helix threads of the nylon collar 22 of a rotator sleeve 21, or has two female legs and one male leg. The tee 23a to provide for branching a single hose into two hoses. Additionally, the tee 23a can have three identical legs that are either all male legs 23b or all female legs 23d, within the scope of this disclosure.

For this disclosure the letters CNC are understood to stand for computer numeric controls that are usually metal, and CNC is used herein to indicate a precision part.

A twist-barb fitting 26, shown in FIG. 4, is the female component of the CNC rotator assembly 19 and includes, as shown in FIGS. 4 and 5A, a circular disk plate 27 configured as a screw thread that is dimensionally constant for all fitting variants to mate to the helix thread grooves 25 within the nylon collar 22 that is press fit into the rotator sleeve 21, as shown in FIG. 5A, and has geometry that matches, to fit snugly over, the outer surface of the snap-barb fitting 23 coupling end 24a, sealing thereto. The other end of which twist-barb fitting 26 is formed to taper outwardly from a forward to rear end edge 28a, as a hose barb end 28 that, when a hose is fitted thereover, slides freely into the hose interior to where the hose is stopped against a forward surface of a collar 29, and with the rear end edge 28a urged into the hose interior wall, resisting hose removal, when an attempt is made to pull the hose off of the hose barb end. In practice, the diameters of the of the hose barb ends 24d and 28 are selected for a particular inside diameter of hose. Unlike earlier rotator assemblies the invention, by employing a single rotator sleeve 21 with nylon collar 22 press fit therein to receive and couple with the respective snap-barb and twist-barb fittings 23 and 26 with different size barb ends, respectively, allows for coupling of hoses that have different inside diameter ends. The universal kit therefore requires only a limited number of the more expensive metal sleeves 21 and nylon collars 22, along with a variety of the lesser expensive nylon snap-barb and twist-barb fittings to provide sufficient connectors to form a hose web for most motor vehicles.

The CNC rotator assembly 19, as shown in the sectional view of FIG. 5E, provides for coupling hoses 40 that are shown also in broken lines in FIG. 5B. The CNC rotator assembly 19 provides for independent rotation of the respective hoses and snap-barb and twist-barb fitting 23 and 26, respectively, preventing hose twisting during assembly or disassembly. The unique metal rotator sleeve 21 offers a high quality visual appearance, color and texture surfacing options, larger gripping surface and can be manufactured in varying lengths, and as it is the sleeve only that is manufactured from metal, preferably aluminum, to receive the nylon collar 22 press fitted therein, the cost thereof is minimal. Though, manufacturing the less expensive nylon snap-barb and twist-barb fittings used to form the CNC rotator assembly 19, requires that more snap-barb and twist barb fittings be included in the kit than rotator assembly sleeves 21 to fit hoses having different inside diameters, they are still cheaper to produce than a rotator assemblies as are currently manufactured as single units. The CNC rotator assemblies 19 are the same for any hose web that the kit connectors can be used to form, where the outer surface of the snap-barb coupling is tapered from its end to receive an inner surface of the twist-barb 23 coupling end, providing sealed contacting surfaces, with the only variations are the diameter of the snap-barb and twist-barb fittings 23 and 26 at their hose barb ends 24d and 28.

FIG. 5C is a view like FIG. 5B, except that a short length rotator sleeve 21 has been included that is like the rotator sleeve 21 of the CNC Rotator assembly 19, but does not include the nylon collar and is arranged to receive the twist-barb fitting 26 collar 29 fitted in binding engagement therein, providing for covering most of the hose barb 28, providing a double sleeve coupling, providing a different coupling appearance. This arrangement is used to provide a clean aesthetic look and protects the assembled coupling. Moreover, the rotator sleeve 21 can be made slidable such that its position on the coupling or couplings can be adjusted.

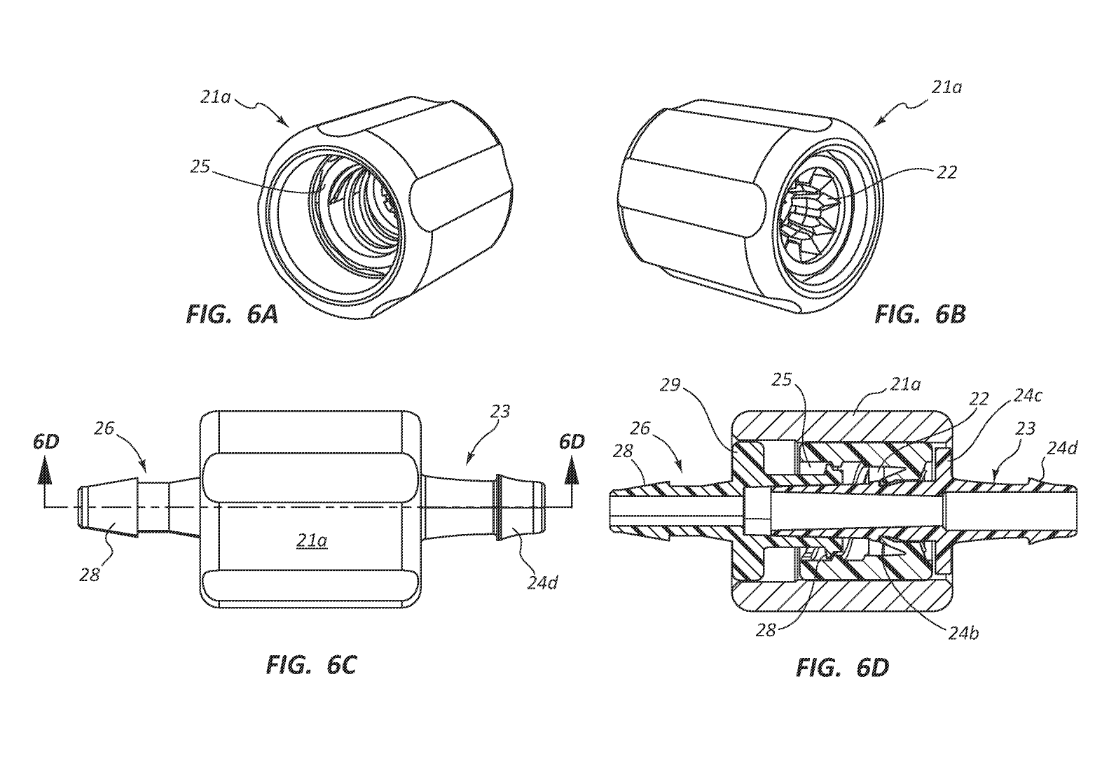

FIGS. 6A and 6B show a longer rotator sleeve 21a that includes the nylon insert 22 and helix threads 25, with, as shown best in FIG. 6A, leaving a gap between the rotator sleeve 21a end and the helix threads 25, that accommodates travel of the twist-barb fitting collar 29 into the sleeve 21a open end, as shown in FIG. 6C and in the sectional view of FIG. 6D. In practice, the longer rotator sleeve 21a design does not necessarily inhibit disassembly of the coupled fittings. In practice, the fittings can be assembled or disassembled by grabbing the tubing where the barb is inserted and twisting. The barb portion of the fitting provides rigidity, thereby preventing the hose from collapsing when firmly gripped.

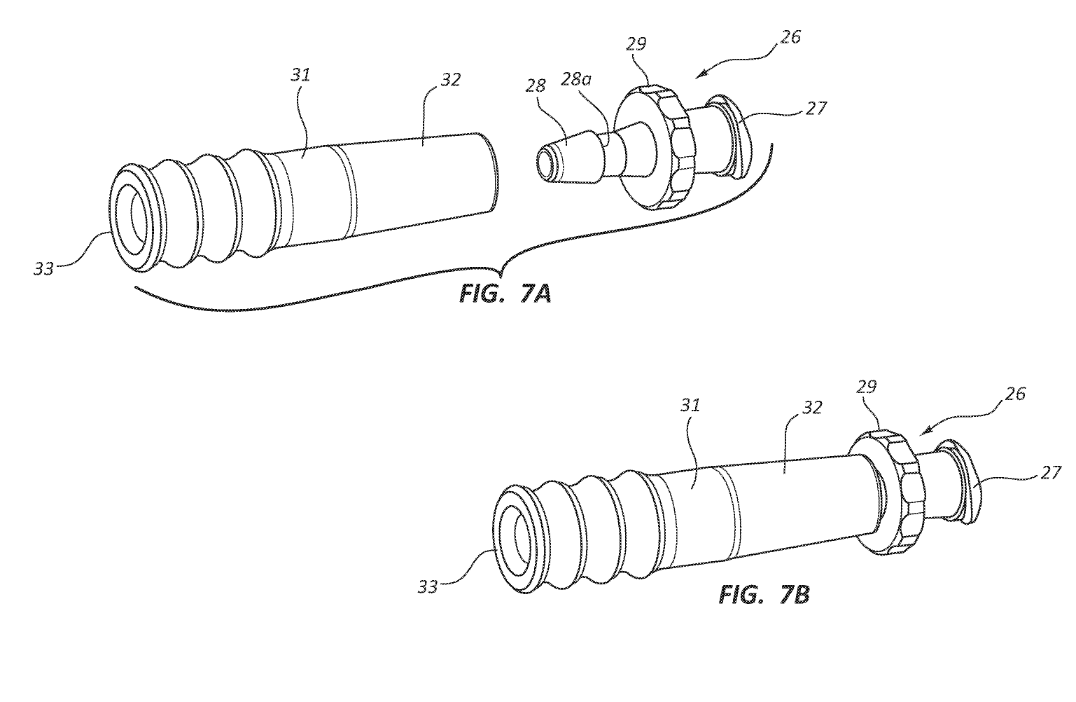

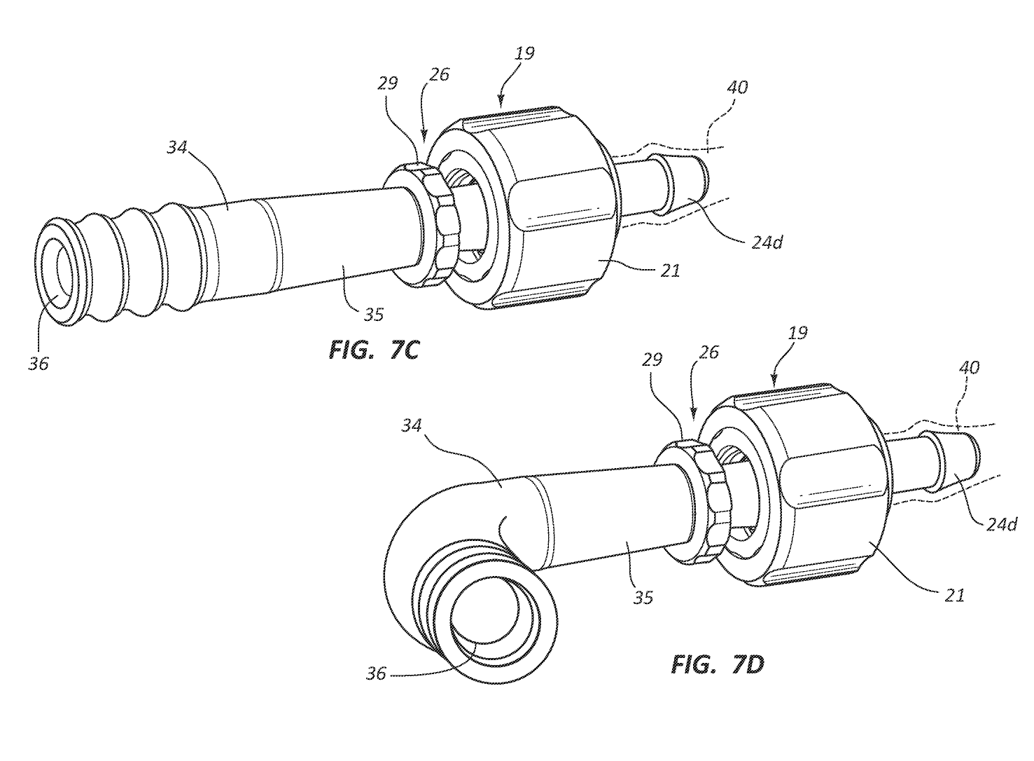

FIG. 7A illustrates a use of the female twist-barb fitting 26 for coupling into one of the accessory components of the kit, a straight rubber nipple connector 31. The straight rubber nipple connection has a hose coupling end 32 for fitting over and locking onto the hose barb end 28 of the twist-barb 26, and has a port coupling on its forward end. FIG. 7B shows the straight rubber nipple connector 31 connected onto the hose barb end 28 of the twist-barb 26. It should also be noted that the rotator assembly 20 can also be attached to the rubber nipple connector 31 end 32, providing increased versatility of the modular hardware of the kit.

FIG. 7C shows a mounting of the rubber nipple connector 31 of FIGS. 7A and 7B onto the hose barb end of the twist-barb 26 whose plate 27 is configured as a screw thread and has been turned into helix thread grooves 25 of the rotator sleeve 21 nylon insert. In FIG. 7D the rotator assembly is shown as having been connected to a ninety degree angle rubber nipple connector 34 hose end 35 and includes a port barb coupling 36 on its forward end.

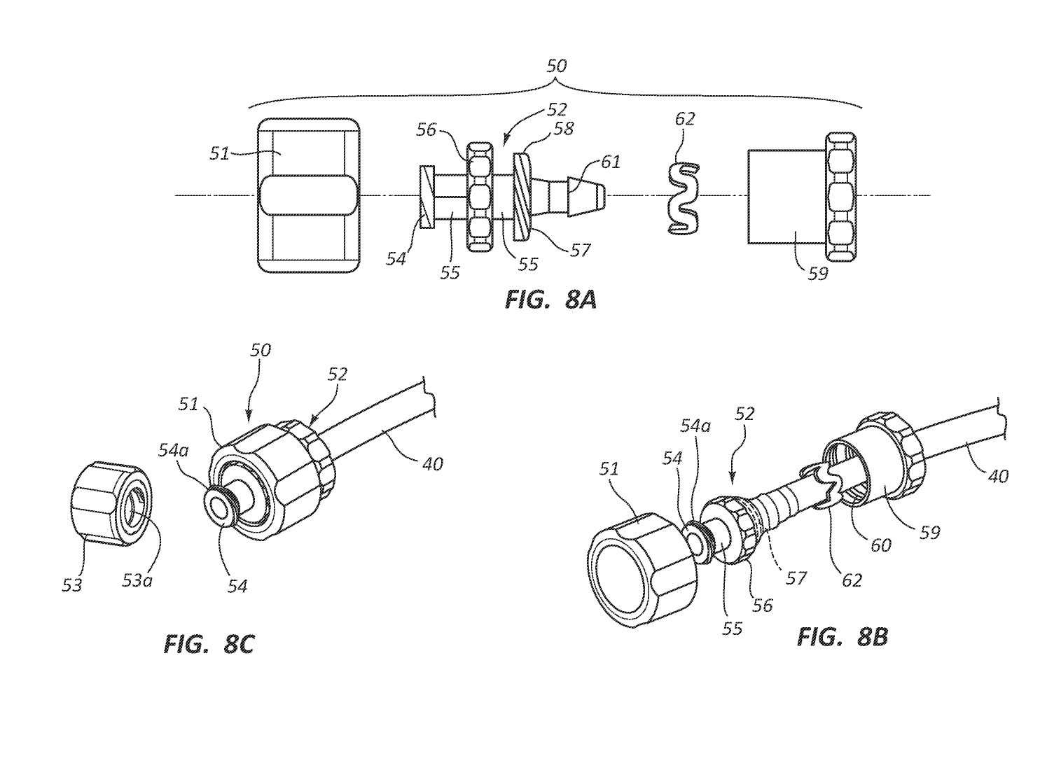

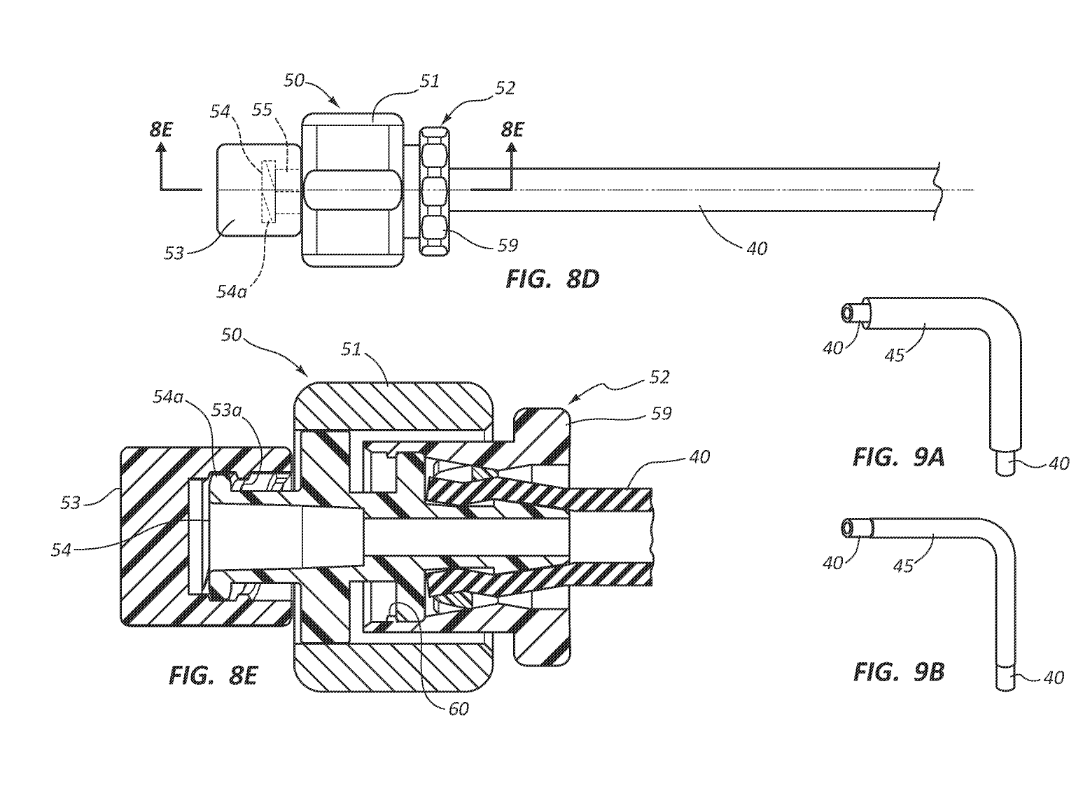

FIGS. 8A through 8E show the components and final arrangement of a hose safety connector 50 that incorporates a sleeve 51, that is like the rotator sleeve 21 but does not include the nylon insert 22 of the above Figures. The sleeve 51 is formed from metal, preferably aluminum, and is to contain and maintain a hose safety fitting 52 installed thereto. The hose safety fitting 52 includes a coupling plate 54 on a forward end thereof whose outer edge is formed as a screw thread that may receive interior helix threads 53a that are formed in a cap 53, that is shown as a sectional view in FIGS. 8C, 8D and 8E, to lock the cap 53 onto the end of the hose safety fitting 52, as shown best in FIGS. 8D and 8E. The hose safety fitting 52 includes a circumferential ring 56 formed around a center shaft 55 whose outer circumference is just less than the interior diameter of the sleeve 51 so as to allow the circumferential ring 56 to be press fit into the sleeve 51 to the attitude shown in FIGS. 8C through 8E. To connect a hose 40 end to the hose safety fitting 52, a mating disk 57 is arranged rearwardly from the collar 56, whose outer surface is formed as a thread 58 that is to turn into helix threads 60 formed around the interior of a locking collar 59, for securing the locking collar onto the hose safety fitting 52. Which hose safety fitting 52, rearwardly from the mating disk 57, includes a hose barb end 61 that is like, and will function like, the hose barb ends discussed above. Additional to the hose barb end 61, for additionally securing a hose 40 end onto the hose barb end 61, a plastic insert or spring 62, shown in FIGS. 8A, 8B and 8E, is arranged over the hose safety fitting center shaft 55 to be urged against the hose 40 outer surface, above the hose barb end 61, blocking pulling the hose end off of the hose barb end. Further, where the hose safety connector 50 is shown for use for capping a hose 40, it should be understood, that the coupling plate 54 of the hose safety fitting 52 could, and is preferably of, a diameter to fit and turn within the helix threads of the nylon insert 22 that has been fitted into the rotator sleeve 21, allowing the hose safety fitting 52 to be attached in-line to the metal sleeve 21 with nylon insert 22 of the rotator assembly 20 by turning the disk 54 into the nylon insert helix threads.

In addition to the connectors and components set out above, it should be understood that the universal kit of the invention, additional to the metallic sleeves, nylon plastic quick-connect fitting, barbed couplers, and rubber fittings, includes heat-shrink sleeves 45, as shown in FIGS. 1, 9A and 9B, for hoses, lines, and tubing. The heat shrink sleeves 45 can be labeled and are for insertion over a hose, line, or tubing, as well as over the coupled connectors, as shown in FIG. 1, and are heated to shrink and adhere thereto. The heat-shrink sleeves 45 could be used to identify a hose or simply enhance the look of an ordinary hose or hoses. The heat-shrink sleeve or sleeves can vary in length and have a logo or other graphic imprinted thereon, as desired. FIGS. 9A and 9B, respectively, show an additional use of the heat-shrink sleeve for maintaining a bend in a hose 40. As shown in FIG. 9A, with the hose bent to a desired angle, a heat-shrink sleeve 45 can be fitted over the hose to cover the bend, and the sleeve 45 is then heat treated to shrink into contact with the hose to permanently maintain the hose in a bent state, as shown in FIG. 9B.

As shown and described herein, the universal kit of the invention is in a selection of different quick-connect connectors, including the CNC rotator assembly, and includes complementary fittings, rubber fittings and/or metallic sleeves that are provided to allow a user to retrofit hoses or lines on an engine, carburetor of other pressure devices. With the exception of the components that are press fitted together, such as the nylon collar that is press fitted into the rotator sleeve, the individual kit components are maintained loose within a container, and are individually selected by a kit purchaser to function with the inside diameter of the hoses that are to make up a web of hoses, and to mate ends of those hoses to form a matrix within the space available. The kit arrangement allows a purchaser to conveniently select appropriate connectors from the kit to form a hose web for essentially any vehicle vacuum or pressure system.

In summary, the metallic sleeve and nylon plastic fittings, as disclosed herein, provide a synergy not found in typical hose connectors. In addition to the aesthetic appeal of metallic versus the “cheap” look of plastic, embodiments of the invention provide cost savings, may include color coding, provide an improved hose lock capability, and prevent the over-tightening of fittings. Performance is increased or maintained due to the more reliable connections, lessens a chance of damage, and reduces labor time needed to form a hose web with the quick-connect fittings of the universal kit of the invention. Additionally, using sleeves and/or fittings of the invention in a plurality of colors allows for color-coding of the types of connections. Allowing certain vacuum or pressure connections within a web of hoses to be readily identified. The design of the sleeve allows for a hose to be inserted into a collar and locked in place, optimizing the relationship between the hose, collar, and sleeve. The fittings of the invention also prevent over-tightening. Since screw-type fittings have no stop, fittings can be tightened to the point where they are very difficult or impossible to disconnect without damaging the hose. The metallic sleeve of the invention can be positioned on two mated fittings to provide a stop past which the fittings cannot be turned.

While a preferred embodiment of the invention is a universal kit containing the selected components as identified has been illustrated and discussed in detail, it should be apparent that modifications and adaptations to those embodiments may occur to one skilled in the art without departing from the scope of the following claims, and a reasonable equivalency thereof, which claims I regard as my invention.

I claim:

1. A universal kit containing connectors and sleeves for forming a variety of vehicle hose webs comprising, a container for housing component connectors of a universal kit that is accessible to a person to remove selected connectors for forming a hose web; a number of CNC Rotator assemblies are primary connectors of the universal kit and each includes a metal like rotator sleeve that receives a collar press fit therein that includes means for connecting and locking to a ridge of a snap-barb fitting passed therein, and said collar includes a molded helix thread adjacent to said means for connecting that receives a circular plate of a twist-barb fitting that has a thread edge where, with the snap-barb fitting held in place, a twist of said twist-barb fitting or said rotator sleeve, turns said circular plate in said molded helix thread to lock the components together such that an inner surface of the twist-barb fitting, at said circular plate end as has slid along an outer tapered surface of said snap-barb fitting ridge end to engage and seal against said snap-barb fitting ridge end outer surface; said snap-barb and twist-barb fittings include hose barb ends that are each for locking to the interior surface of a hose end slid thereover, and each said twist-barb fitting is open therethrough as is said snap-barb fitting, providing an open passage therethrough; and a plurality of connectors each for coupling, on one end, onto a said hose barb end and onto a fixed nipple or port on its other end.

2. The universal kit as recited in claim 1, wherein the rotator sleeves are each formed from aluminum and the collar, snap-barb and twist-barb fittings are each formed from nylon plastic; and the collar means for connecting and locking to the ridge of a snap-barb fitting includes radial one-way flexible fingers that extend inwardly from around said collar means inner surface, with an open center space provided between ends of said flexible fingers.

3. The universal kit as recited in claim 1, wherein the container is a rectangular box that is divided longitudinally by a center wall into two sections that each have divider walls arranged therein that form compartments, and which two sections are each covered by a hinged lid that is opened to expose the compartments in each said section; and each said lid includes a latch for maintaining said lid in covering arrangement over said section.

4. The universal kit as recited in claim 3, wherein the lids are identical and each is convex across its outer surface; and the divider walls are of a height to extend to approximately said lid undersurface, when said lid is closed thereover.

5. The universal kit as recited in claim 1, further including at least one tee fittings that is open therethrough, has either one leg formed with a male snap-barb fitting ridge coupling end for locking into e collar of the metal rotator sleeve, locking across the means for connecting and locking, and with the other two legs formed as female twist-barb fitting circular plate coupling ends for turning in the molded helix thread of metal rotator sleeves, or one tee fitting leg includes said twist-barb fitting circular plate coupling end and the other two legs include said snap-barb fitting ridge coupling ends, or all three legs are formed as female twist-barb fittings circular plate coupling ends or as male snap-barb fittings ridge coupling ends

6. The universal kit as recited in claim 1, further including a hose safety connector that includes a metal rotator sleeve that receives a safety fitting that is open therethrough, includes a circumferential ring to fit snugly within said metal rotator sleeve and has a disk formed on one end thereof having a thread outer surface and is of a diameter to turn into the molded helix thread of the metal rotator sleeve press fit collar, includes a mating disk having a thread outer surface that is to turn in helix threads of a cylindrical locking collar, and includes a hose barb other end; a circular spring having a diameter that is less than an outer edge of said hose barb is arranged for fitting in said locking collar and compresses against a hose end fitted onto said hose barb when said locking collar is turned onto said mating disk.

7. The universal kit as recited in claim 6, further including a cap having an interior helix thread for turning onto the safety fitting disk thread outer surface.

8. The universal kit as recited in claim 1, further including at least one rubber connector having one hose end and with the other end for fitting to a port.

9. The universal kit as recited in claim 8, wherein the connector is bent at a ninety degree angle

10. The universal kit as recited in claim 1, further including a plurality of rotator sleeves that do not include press fit collars.

11. The universal kit as recited in claim 10, further including a mix of short and long rotator sleeves.

12. The universal kit as recited in claim 1, further including at least one sleeve formed from a shrink-wrap material of a diameter to fit over a section of hose or a coupling of hose ends and will, when heated, shrink into contact with said section of hose or said coupling of hose ends.
